(19) United States
(12) Patent Application Publication
(10) Pub. No.: US 2002/0124017 A1
(43) Pub. Date: Sep. 5, 2002

(54) Personal digital assistant with food scale accessory

(76) Inventor: James R. Mault, Evergreen, CO (US)

Correspondence Address: GIFFORD, KRASS, GROH, SPRINKLE,, ANDERSON & CITKOWSKI, P.C., Suite 400, 280 N. Old Woodward, Birmingham, MI, 48009, US

(21) Appl. No.: 09/960,012

(22) Filed: Sep. 21, 2001

Related U.S. Application Data
(60) Provisional application No. 60/234,866, filed on Sep. 22, 2000.

(51) Int. Cl. G06F 7/00

(52) U.S. Cl. 707/509; 707/1

(57) ABSTRACT

The rapid development and acceptance of portable computing/communications devices has given rise to many new and varied applications with respect to monitoring and feedback in the field of the Health Sciences. In particular, portable computing/communication devices have given the consumer/practitioner new and more convenient ways to monitor nutritional intake and adherence to diet plans.

### RELATED APPLICATION

This application claims priority of U.S. Provisional Patent Application No. 60/234,866 filed Sep. 22, 2000 and is incorporated herein by reference.

### FIELD OF THE INVENTION

This invention relates generally to a portable computing/communication device, and more particularly to a device that has the ability to accept plug-in modules/accessories, with the ability to assist in the monitoring of nutritional intake and adherence to a diet plan.

### BACKGROUND OF THE INVENTION

In the field of Health Science it has been established that a subject's daily dietary/nutritional patterns will have a far-reaching effect on his or her health. As the old adage goes, “you are what you eat”. The Surgeon General's Report on Nutrition and Health (United States Department of Health and Human Services, Washington, D.C. 1988) states that “what we eat may affect our risk for several of the leading causes of death for Americans, notably coronary heart disease, stroke, atherosclerosis, diabetes, and some types of cancer.” The United States government has even issued a recommended daily allowance (RDA) of the major nutritional components of a person's diet including, carbohydrates, fiber, fat, protein, major vitamins and minerals.

The advances of Health Science in relation to nutrition, and the effects of diet on a person's health, has led to a growing population of people who either need or want to keep track of their intake of food in order to help control their diet. For example, people wishing to lose weight benefit from tracking their caloric intake on a day-by-day basis. Other people are on restricted diets for any of a variety of reasons, including diabetics who must control sugar intake, persons with high blood pressure who control salt intake, and persons with high cholesterol who must monitor the amounts of cholesterol causing agents they ingest. In each of these situations, and in many others, there is a need to consistently and correctly record all the types and amounts of foods/nutrients consumed, so that person will be assured of accurate nutritional data and adherence to his/her plan will be confirmed.

Dietary intake is made up of two components, what is ingested and how much is ingested. Knowing “what” is being ingested is generally self evident, and usually is relatively straightforward for the consumer to record and track. For example, the consumer can merely record that they are eating a certain brand of cold cereal for breakfast along with milk. In general, food products are required to provide ingredients, recommended serving sizes, and nutritional information per serving, as a part of the information furnished on their label. However, what presents more of a challenge to the consumer is how much is actually being consumed. Consumers are notoriously poor at estimating the quantity of a given food they are eating. In our cold cereal example, the suggested serving size may be listed as one cup. However, most consumers, when asked to pour a one-cup serving of cold cereal into a cereal bowl, will pour considerably more than one cup into the bowl. Consequently, the consumer will considerably underestimate the amount of cold cereal ingested during their morning meal. Even though the amount of cereal consumed was greater than the suggested serving size of one cup, the consumer will record only the targeted amount in the diet plan log. As the day progresses, the process of estimating various food portions will be repeated at each meal, with a good probability that these portions will also be recorded inaccurately. The consistent error in estimating caloric intake will lead to an under-reporting of the actual calories consumed into the daily diet log. The compound effect of the error in food portion estimation and the resultant additional caloric intake will lead to unsuccessful diets and frustrated consumers. Obviously, a careful consumer can accurately measure all portion sizes, or gain access to professional dieticians and food preparers to assist them in measuring their food portions and caloric intake, but these consumers are the exception to the rule.

The primary tool for measuring food portion sizes is the dietary scale. A dietary scale allows a consumer to accurately weigh the portions of each type of food consumed at a given meal. Continuing the cold cereal example, the consumer places the cereal bowl on the scale, zeros the scale, and adds cereal to the bowl until the display of the scale indicates the target weight of the recommended portion. In general, most diet regimens specify serving sizes according to weight, as do most food package labels. The process of weighing out each portion consumed must be repeated throughout the day, and accurate records must be kept of what is eaten. The use of the dietary scale is time consuming, cumbersome, and tedious. The user must carry the dietary scale with them at all times and consistently use the scale to measure portions consumed. This process is too laborious for some users, despite their need or desire to accurately track dietary intake. Also, many users find it embarrassing to use such a scale in front of their friends and family in order to measure all foods consumed. Therefore, there remains a need for an improved approach to measuring portion size and recording the resulting information.

One approach to improving the process of recording dietary intake is offered by diet tracking software of the type disclosed in U.S. Pat. No. 4,891,756. This software runs on a handheld personal digital assistant (PDA) and includes a database of specific foods and food types along with their portion sizes and nutritional content. A user may easily select a specific food consumed from a database stored in the PDA and input the portion size consumed. The software keeps track of all inputs and totals it for a period of time, such as a day or week. This obviously greatly improves the ease with which dietary intake may be recorded. However, it does not address the need to more accurately estimate portion size through weighing or measuring.

As advances are made in portable electronic computing/communication devices, and the level of acceptance of these devices grows, the problems/challenges associated with accurately gauging caloric intake through the measurement and logging of food intake can be minimized. The tedious and obtrusive nature of measuring and logging amounts and types of food can be made less conspicuous by employing devices that consumers normally carry with them including PDAs, personal organizers, cellular phones, pagers, wristwatches, and other computing and storage devices. Various configurations and methods of information and data exchange can be employed with the aforementioned information appliances in tandem with measurement devices to carryout the dietary objectives of the consumer.

### SUMMARY OF THE INVENTION

The present invention is accordingly directed toward a system employing a PDA with an application program which allows a user to store signals representative of food items consumed for the purpose of calculating the consumption of calories or other nutrients and a scale for weighing food portions to be consumed, or consumed, so that the weight of the portions may be used in determination of the calories or other nutrients.

More particularly, the present invention is directed toward a system wherein the PDA contains a database of consumable categories and their caloric or nutrient value which may be used along with the measured weight of the portion to determine the caloric or nutrient value consumed.

In a preferred embodiment of the invention, the scale for weighing the portion consumed or to be consumed is integrated with the PDA through a connector which physically supports the scale on the PDA and electrically connects the output of the scale to the PDA.

### BRIEF DESCRIPTION OF THE DRAWINGS

The present invention will be disclosed in connection with the accompanying drawings, in which:

FIG. 1 is a perspective view of a conventional PDA useful in connection with the present invention;

FIG. 2 is a perspective view of a PDA engaged in a docking cradle/module that is integral to the dietary scale of the present invention;

FIG. 3 is a perspective view of a PDA in wireless communication with a dietary scale;

FIG. 4 is a perspective view of a PDA tethered via a data cable to a dietary scale;

FIG. 5 illustrates a scale with a PDA cradle;

FIG. 6 schematically illustrates wireless communication of data to a PDA in a food service setting;

FIG. 7 is a perspective view of a PDA engaged in a docking cradle/module that is integral to a dietary scale linked to a display/printer unit;

FIG. 8 illustrates a detachable scale module tethered via a data cable to a PDA;

FIG. 9 illustrates a scale module in wireless communication with a PDA;

FIG. 10 is a perspective view of an integral PDA/dietary scale unit; and

FIG. 11 illustrates a PDA/dietary scale unit with a hook.

### DETAILED DESCRIPTION OF THE PREFERRED EMBODIMENTS

The portable computing/communication device of the present invention may be embodied in any number of different types of personal digital assistants (PDAs). PDAs include the Palm Pilot family of products, devices running on the Palm operating system, Microsoft Windows CE-based handheld computers, and many others. For the purposes of this application, PDAs are defined to include all types of portable computing/communication devices including; palm size and handheld computers, wearable computers, portable and cellular phones, pagers, wristwatches, and any other information appliances which are portable, possess computational ability, memory storage, and the ability to input/output information. The preferred embodiment of the present invention includes the utilization of smart cards, flash memory sticks, or other portable data storage devices to facilitate the transfer of data to and from the PDA. In yet another preferred embodiment of the present invention, the PDA is capable of communicating with other computers, by such means as the Internet or a modem. The PDA's ability to establish external communication links allows health professionals such as trainers or physicians to monitor a patient's adherence/progress with respect to a diet/nutritional plan without the need for an office visit.

The present invention operates to assist individuals in attaining their dietary goals. Information relevant to the individual's health is inputted into the PDA/computing device of the present invention, stored and analyzed. The PDA then returns suggestions and feedback to the user on their diet or nutritional plan. In a further preferred embodiment of the present invention, the PDA of the present invention may create graphs, tables, and charts based on the data it has stored. These visual aids may then be printed or displayed by the PDA.

Upon purchasing a food product, the user inputs information regarding the product. This information may be input by a number of different methods, including scanning the Universal Product Codes (barcode) provided on the packaging of the product, or entering the type of food by pressing buttons on the PDA. In a preferred embodiment of the present invention, the PDA includes a database of the nutritional information of various food products. By scanning the barcode of a product or inputting a type of food product, the computing device of the present invention can thus retrieve all nutritional information for that product. Combined with the weight of the product, an accurate diet log entry can be made.

The PDA may be used to record notes associated with the weighed items. For example, an image of an item may be recorded along with its weight, for future use in creating a diet log. A voice memo may also be recorded on the PDA. An identifying barcode associated with the product may be scanned with a barcode reader either built into or otherwise in communication with the PDA. Printed information may be scanned or imaged, and optical character recognition used to extract product identity, and possibly nutritional information from a database.

The user may also enter personal data, or information for another individual, into the memory of the PDA. This individual's data may include age, gender, health problems, height, weight, and other factors pertinent to the maintenance of a diet. The individual's data is stored by the computing device of the present invention, and may be used by the computing device for the purpose of analysis, as discussed below. The above-mentioned inputs may all be stored in a RAM database.

Upon every entry of a food intended to be purchased or consumed, the computing device (PDA) of the present invention analyzes the user's choice of food. The computing device then provides feedback to the user based on the food choice and other stored data. This feedback may include the nutritional information of the food choice as well as information regarding the overall progress of the individual's diet.

The feedback, provided by the computing device of the present invention, might also include a suggestion as to an alternate product with superior nutrition. In order to provide a list of alternate products the computing device may be in communication with, or include a database from, the restaurant that the user frequents. If the user is at home and intends to consume food previously purchased, the computing device can retrieve data previously entered upon its purchase in order to provide feedback.

Any information stored in the computing device of the present invention may be printed by conventional means. A printing device may be provided at locations such as grocery stores, restaurants, and the user's home. Additionally, the preferred embodiment of the present invention can be placed in electrical communication with a personal computer to facilitate the printing of data at the user's home. Connection to a personal computer may also make data entry into the computing device of the present invention easier.

FIG. 1 shows a conventional PDA 10 having a display screen 12, and a plurality of buttons/controls/data interface 14 to enable the user of the present invention to input various data/commands and interconnect with other devices.

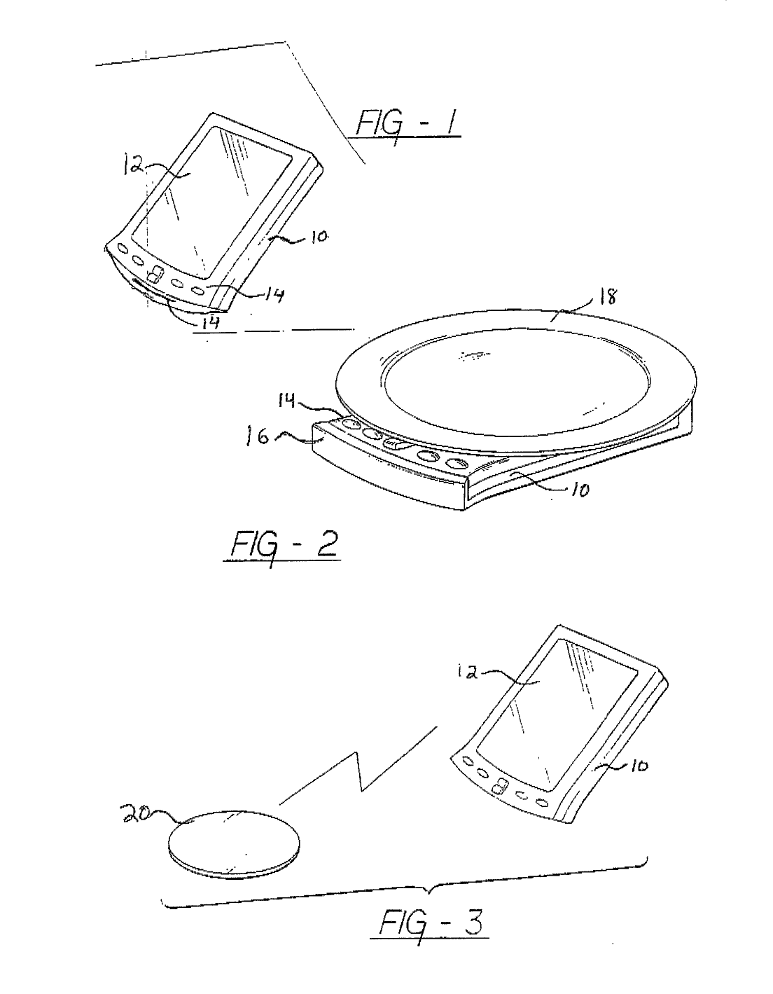

FIG. 2 shows PDA 10 docked with a module (or frame) 16 having a built-in scale. The module 16 has a generally C-shaped housing that defines a docking interface for the PDA. The size of the module 16 is only slightly larger then the PDA 10, allowing for easy portability for the user in an inconspicuous manner. The module 16 connects to the PDA 10 via the PDA's 10 data interface 14 through a connector which joins the electrical output of the scale to the PDA. A floating connection, such as a ribbon cable with a connector adapted to the particular data interface 14, may be used. The PDA may be of the type disclosed in U.S. Pat. No. 5,899,855, which has a slot for accepting a data module and connection may be through that slot. The module 16 has one or more internal strain (or stress) gauges to determine the downward force (converted to a weight reading) exerted on the module 16 by the plate (or glass for liquids) 18. In use, the module 16 is docked with the PDA 10, placed on a flat surface, and an object to be weighed is placed on top of the combination so that the weight of the item presses downwardly on the housing of the module 16.

A protective cover, with appropriate openings to allow access to the keys 14, may be placed over the display 12 and keys 14 of the PDA 10 during the weighing process. On docking the module 16 to the PDA 10, the PDA 10 preferably recognizes the module 16 and loads appropriate software either from the memory of the PDA 10 or from the module 16. For the purpose of weighing food, a user places a plate 18 onto the module-based scale 16, zeroes the scale by pressing a button 14, and then adds food to the plate 18. The weight of the food is then determined. The user can later place any unused food portion on the scale, to determine the actual final weight of the food consumed. The type and quantity of food consumed can thus be recorded and analyzed with reference to the user's diet plan. A configuration in which the docked combination is inverted, and the plate 18 placed on the module 16, may also be employed. In this inverted configuration, the module 16 may be self supporting, so that no weight force is exerted on the PDA 10. In the inverted configuration access to the buttons 14 on the PDA 10 may be impaired, so that an audible tone can be used to indicate that a steady state zeroing weight has been obtained upon placement of the plate 18. When the food to be weighed is placed on the combination, a second audible tone is emitted. The steady state weight values or averages may be obtained from changing time-dependent weight values, for example using an algorithm on the PDA 10 or resident in the module 16. The audible tones may be generated by the PDA 10 or the module 16. Voice recognition technology may be employed, to allow the user to zero the scale, and weigh food via commands such as “zero” and “weigh.” The module 16 may also include indicator lights, buttons for initiation of weighing items and recording the obtained values, and a numeric display to show the resultant measurement. The module 16 may come preloaded with nutritional and diet tracking software, as well as having on-board memory storage capabilities.

FIG. 3 illustrates a scale 20 in wireless communication with the PDA 10. Such communication may be achieved using the Bluetooth wireless protocol, or via IR (infrared) link. The scale 20 may have the form factor of a placemat, coaster, plate, beverage container, disk, rectangular plate, book, memory card, mouse pad, or other object. A cafeteria setting would be perfect for the scale 20. As a person is selecting food per their dietary/nutritional plan, they would select a food category and add this food to the scale 20. When the desired amount of the particular food or beverage is placed on the scale 20, an indicator on the display 12 of the PDA 10, or an audible tone from the PDA 10 would alert the user that the proper quantity of the consumable has been placed on the scale. At the time of purchase, the types and amounts of food chosen can be relayed to the cashier to determine the customer's bill.

FIG. 4 illustrates a scale 20 with a data cable 28 connection to the PDA 10. The weight of the food portions is determined using the scale 20, and is displayed/recorded on the PDA 10 as part of a diet log.

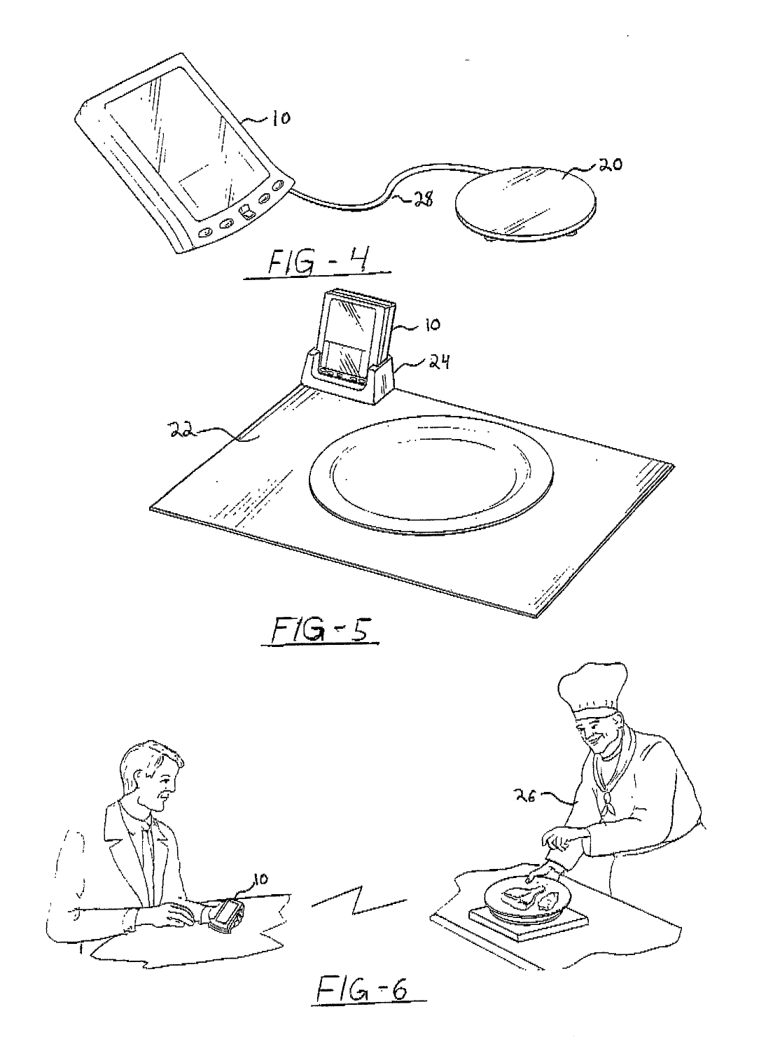

In the embodiment of the invention shown in FIG. 5, a weighing placemat 22 has an interface 24 to a PDA 10. A plate 18 is placed on the placemat 22, which has a built-in scale, such as a pressure-sensitive mat. The weight recorded by the weighing placemat is transmitted to the PDA 10 via the fixed interface 24. A cable link or wireless link may also be employed. In a cafeteria setting, multiple placemats 22 would be available by each food group, to allow the user to record each food selected and its amount. At the time of purchase, the types and amounts of food chosen can be relayed to the cashier to determine the customer's bill.

FIG. 6 shows a food service worker 26 weighing a food serving before providing it to a customer. The weights of different meal components may be measured separately. Data is shown being transmitted via a wireless link to the customer's PDA 10. Data may alternatively be transmitted to a display device or data port on the diner's table.

FIG. 7 illustrates a PDA 10 docked with a module 16 with a built-in scale. The module 16 communicates with a separate weight display unit 34 having a display 32 and a printer 30. The weight display 32 communicates to the user the combined weight of any food, dishes, and packaging placed on the module scale 16. Through this feedback, the user can better control adherence to the diet. The weight display unit 34 may be in communication with the PDA 10 by wireless means, or by means of a cable 28. The weight display unit 34 may additionally include a means for creating a weight printout 30 based upon the weight of what is placed on the scale 16. The weight printout 30 may include printed barcodes to facilitate data entry to the PDA 10.

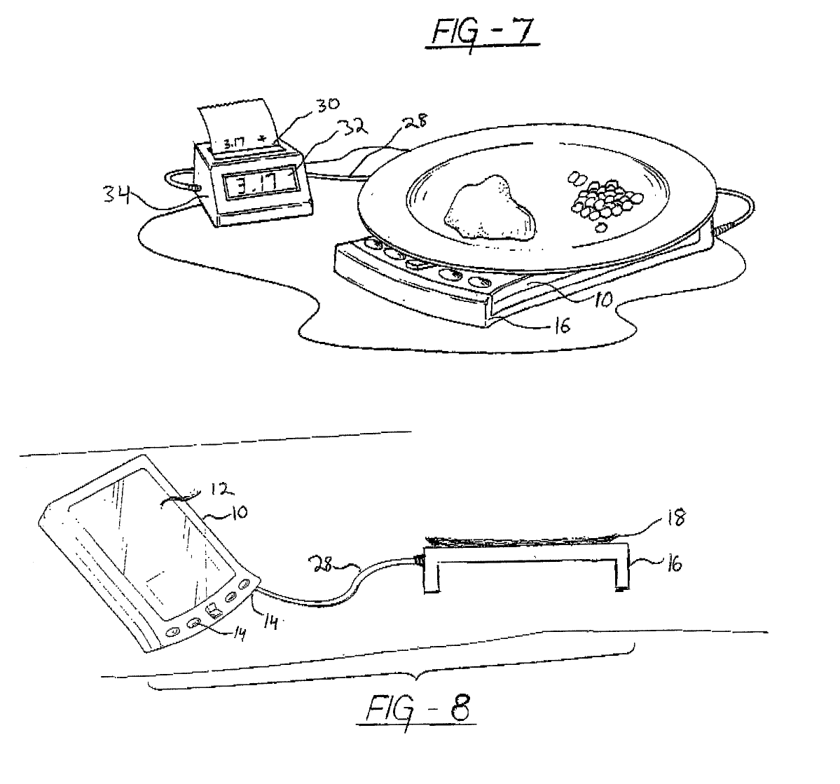

FIG. 8 illustrates a PDA 10 undocked from a module (or frame) 16 having an in-built scale. The module 16 has a generally C-shaped housing that defines a docking interface for the PDA 10. The size of the module 16 is only slightly larger then the PDA 10, allowing for easy portability for the user in an inconspicuous manner. The module 16 connects to the PDA 10 via the PDA's 10 data interface 14 through a connection, such as a cable 28 with a connector adapted to the particular data interface 14. The module 16 has one or more internal strain (or stress) gauges to determine the downward force (converted to a weight reading) exerted on the module 16 by the plate 18. In use, the module 16 is undocked from the PDA 10, a cable 28 connection established, and the module is placed on a flat surface. A plate 18 is placed on the module 16 and an object to be weighed is placed on top of the combination so that the weight of the item presses downwardly on the housing of the module. On docking the module 16 to the PDA 10, the PDA 10 preferably recognizes the module 16 and loads appropriate software either from the memory of the PDA 10 or from the module 16. For the purpose of weighing food, a user places a plate 18 onto the module-based scale 16, zeroes the scale by pressing a button 14, and then adds food to the plate 18. The weight of the food is then determined. In this mode, full use of the PDA's 10 display screen 12 is available, during the measurement process, to illustrate the output readings of the module scale 16.

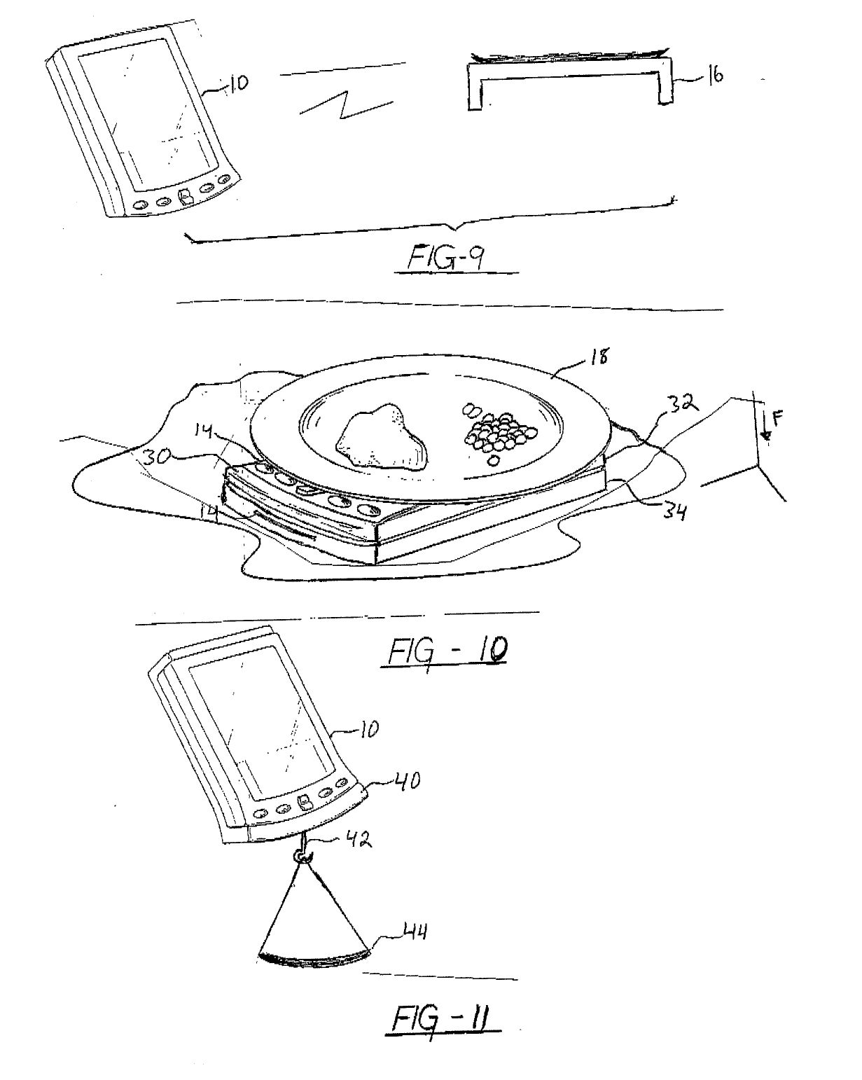

FIG. 9 shows a similar configuration to FIG. 8, however a wireless link is employed between the module scale 16 and the PDA 10.

An integral PDA/dietary scale unit 30 is illustrated in FIG. 10. The housing of the integral PDA/dietary scale unit 30 contains the requisite circuitry (stress/strain gauges) to determine weight loading through the compressive forces exerted on the unit 30. The housing of the unit 30 is composed of a front portion 32, and a rear portion 34, which are connected in a manner to allow movement along the vertical axis in the direction of the compression force applied. The front portion 32 contains the display screen 12, and a plurality of buttons/controls/data interface 14 to enable the user of the present invention to input various data/commands and interconnect with other devices. The rear portion 34 contains the weight sensing circuitry, and provides a reading in proportion to the compression of the front portion 32 with respect to the rear portion. In operation, the rear portion 34 of the unit 30 is placed on a flat surface, and the front portion 32 is used to support a plate (or glass for liquids) 18. When a steady state reading is obtained with the plate 18 on top of the unit 30, an audible tone is emitted to indicate that the scale is now zeroed. Once the unit 30 is zeroed with the plate 18, the user can place the food to be measured on the plate 18 and a second audible tone is emitted when a steady state weight reading has been determined.

FIG. 11 illustrates an embodiment of the invention employing a PDA 10 with a hanging accessory 40 and hook 42 docked to the PDA 10. The hanging accessory 40 locks onto the PDA 10, and mates up with the data interface 14 of the PDA 10. The hook 42 is connected to a strain gauge contained in the hanging accessory 40. A cradle 44 is hung from the hook 42, and a signal related to the weight of the object hung is provided to the PDA 10.

Having thus described my invention, I claim:

1. A system for determining the nutritional composition of foods, comprising:
a personal digital assistant (PDA) comprising a housing, a microprocessor, display screen and user input means;
a database with a plurality of foods and their nutritional content per serving size stored in the PDA;
a scale for weighing food portions and generating electrical signals proportional to the weight; and
circuitry providing the electrical output of the scale to the PDA;
whereby the user may select a food type on the PDA, weigh the food portion, and thus determine the nutritional content of the food portion.

2. The system of claim 1 wherein the nutritional content constitutes caloric content.

3. The system of claim 1 wherein the PDA includes a program for storing entries relating to the nutritional contents of foods consumed and accumulates those entries over a period of time to record nutritional consumption over a period of time.

4. The system of claim 1 wherein the PDA has a slot for accepting data modules and the scale includes a connector that plugs into the slot to support the scale on the PDA and electrically connect the scale to the PDA.

5. The system of claim 1 wherein the connection between the scale and the PDA is wireless.

6. The system of claim 5 wherein the wireless connection is radio frequency.

7. The system of claim 5 wherein the wireless connection is infrared.

8. The system of claim 1 further including communication means in the PDA to transmit stored information into a public network so that the nutritional consumption of a user may be determined at a remote location.

9. The system of claim 1 wherein the scale employs strain gauges to measure the weight of food portions.

10. A system for determining and recording the nutritional contents of the food portions consumed by a user on a daily basis, comprising:
a personal digital assistant (PDA), comprising a housing, a microprocessor, a user display, user entry keys, a database of the nutritional contents of each of a plurality of food portions, per unit weight, and means for recording and accumulating user entries;
an electronic scale for food portions; and
means for providing the output of the scale to the PDA;
whereby the user may use the entry keys of the PDA to select a particular food type, weigh a portion of that food type on the scale to determine the quantity of food type, and the PDA will record and accumulate the nutritional content of the food portions consumed.

11. The system of claim 10 wherein the nutritional content constitutes caloric value.

12. The system of claim 10 wherein the PDA further includes communication means for transmitting information stored therein to a remote device.
